(19) United States
(12) Patent Application Publication
(10) Pub. No.: US 2025/0192668 A1
(43) Pub. Date: Jun. 12, 2025

(54) ELECTRIC-POWER CONVERSION APPARATUS

(71) Applicant: Mitsubishi Electric Corporation, Tokyo (JP)

(72) Inventors: Hayato NAKATA, Tokyo (JP); Masakazu TANI, Tokyo (JP); Katsuhisa KODAMA, Tokyo (JP); Takuya NAKAMURA, Tokyo (JP)

(73) Assignee: Mitsubishi Electric Corporation, Tokyo (JP)

(21) Appl. No.: 18/821,202

(22) Filed: Aug. 30, 2024

(30) Foreign Application Priority Data
Dec. 11, 2023 (JP) 2023-208128

(51) Int. Cl. H02M 1/32; B60L 15/00; H02M 7/00

(52) U.S. Cl. CPC H02M 1/32; B60L 15/007; H02M 7/003

(57) ABSTRACT

There is provided an electric-power conversion apparatus that can suppress bending of a substrate at a time when vibration occurs in the substrate.

The electric-power conversion apparatus includes
a semiconductor module having a main body portion held to a case and two or more control terminals pulled out from the main body portion,
a substrate on which respective connection portions to which the two or more control terminals are fixed in substantially linear alignment are arranged in such a way as to be substantially parallel to the alignment direction and in such a way as to face each other, and
a transformer that is mounted at a position, on the substrate, avoiding a virtual center line, the respective distances from which to the facing connection portions are equal to each other, and whose gravity center is apart from a first mounting surface of the substrate in the normal direction.

### BACKGROUND

The present disclosure relates to an electric-power conversion apparatus.

In the case where in a conventional electric-power conversion apparatus, a supported portion such as a penetration hole is provided in the central portion of a substrate on which electronic components included in an electric circuit, it is required that the electronic components are mounted in such a way as to avoid the supported portion; thus, in order to prevent the substrate from being enlarged, the supported portion is provided only in an outer-edge portion (e.g., refer to Patent Document 1). In addition, in this electric-power conversion apparatus, when the substrate vibrates, displacement due to bending is enlarged in the central portion where no supported portion exists and this bending becomes larger in proportion to the weight of the electronic component to be mounted; thus, a transformer, among the electronic components to be mounted on the mounting surface of the substrate, that has a large weight is mounted closer to the outer-edge side than the other components, so that the vibration resistance is raised by suppressing the bending of the substrate.
[Patent Document 1] Japanese Patent Application Laid-Open No. 2021-40453

In the foregoing conventional electric-power conversion apparatus, two or more connection portions are provided linearly aligned on the substrate; each of the connection portions is connected with control-terminal groups pulled out from respective inverters each provided with a switching device. In this case, when the substrate vibrates, displacement due to bending becomes large in the portions that are situated between corresponding ones of two or more connection portions, with which the control-terminal groups of the inverters are connected, and are apart therefrom, i.e., on a virtual center line, from which the respective distances to the facing connection portions are equal to each other, in addition to the central portion, of the substrate, that is apart from the respective supported portions.

In addition, in the foregoing conventional electric-power conversion apparatus, a transformer is disposed on the foregoing virtual center line. In general, the gravity center of a transformer is high with respect to the mounting surface of a substrate. When vibration in the surface direction of the substrate occurs in the substrate, inertial force generated in such a component whose gravity center is high with respect to the mounting surface makes the head-top portion of the component vibrate, as if a pendulum, on the mounting portion of the component, as a fulcrum. Accordingly, in the substrate, force is exerted in the normal direction of the mounting surface thereof from the mounting portion of the component; thus, vibration that bends the substrate in the normal direction occurs.

In the foregoing conventional electric-power conversion apparatus, the transformer whose gravity center is high with respect to the mounting surface of the substrate is mounted on the foregoing virtual center line where the displacement due to the bending is liable to become large; thus, when the transformer vibrates in the surface direction of the mounting surface of the substrate, substrate resonance in which the foregoing connection portions are nodes and a loop is made in the region sandwiched between the facing connection portions is liable to occur and the amplitude thereof becomes large; therefore, the bending of the substrate is liable to become large. Accordingly, because when the substrate vibrates, stress that is exerted on the substrate itself or the connection portion between the substrate and the control-terminal group of the inverter becomes large, the substrate may be broken.

### SUMMARY

The present disclosure has been implemented in order to solve the foregoing problem; the objective thereof is to obtain an electric-power conversion apparatus that can suppress bending of a substrate at a time when vibration occurs in the substrate.

An electric-power conversion apparatus according to the present disclosure includes
a semiconductor module having a main body portion held to a case and two or more control terminals pulled out from the main body portion,
a substrate on which respective connection portions to which the two or more control terminals are fixed in substantially linear alignment are arranged in such a way as to be substantially parallel to the alignment direction and in such a way as to face each other, and
a mounting component that is mounted at a position, on the substrate, avoiding a virtual center line, the respective distances from which to the facing connection portions are equal to each other, and whose gravity center is apart from a mounting surface of the substrate in a normal direction thereof.

In the electric-power conversion apparatus according to the present disclosure, the respective connection portions, at which the groups of the control terminals pulled out from the semiconductor module are fixed to the substrate in substantially linear alignment, are arranged in such a way as to face each other, and the mounting component whose gravity center is apart from the mounting surface of the substrate in the normal direction thereof is mounted at a position avoiding the virtual center line, the respective distances from which to the facing connection portions are equal to each other; therefore, because when vibration occurs in the substrate, substrate resonance in which the connection portions are nodes and a loop is made in the region sandwiched between the facing connection portions hardly occurs, bending in the substrate can be suppressed.

The foregoing and other object, features, aspects, and advantages of the present invention will become more apparent from the following detailed description of the present invention when taken in conjunction with the accompanying drawings.

### BRIEF DESCRIPTION OF THE DRAWINGS

FIG. 1 is a view illustrating an example of the installation state of an electric-power conversion apparatus according to Embodiment 1;

FIG. 2 is a top view illustrating the electric-power conversion apparatus according to Embodiment 1;

FIG. 3 is a cross-sectional view taken along the line A-A, illustrating the electric-power conversion apparatus according to Embodiment 1;

FIG. 4 is a top view illustrating the electric-power conversion apparatus according to Embodiment 1;

FIG. 5 is a perspective view illustrating the electric-power conversion apparatus according to Embodiment 1;

FIG. 6 is a top view illustrating the electric-power conversion apparatus according to Embodiment 1;

FIG. 7 is a top view illustrating the electric-power conversion apparatus according to Embodiment 1;

FIG. 8 is a cross-sectional view illustrating an electric-power conversion apparatus according to Embodiment 2;

FIG. 9 is a top view illustrating an electric-power conversion apparatus according to Embodiment 3;

FIG. 10 is a top view illustrating an electric-power conversion apparatus according to Embodiment 4; and

FIG. 11 is a top view illustrating the electric-power conversion apparatus according to Embodiment 4.

### DETAILED DESCRIPTION OF THE EMBODIMENTS

### Embodiment 1

An electric-power conversion apparatus 100 according to Embodiment 1 is mounted in a vehicle such as an electric automobile, a hybrid electric automobile, or a fuel-cell vehicle and supplies a motor of the vehicle with electric power supplied from a power source, while converting the voltage, the current, the frequency (including also the direct current having zero frequency), and the like. Because when the vehicle travels, vibration occurs therein, the vibration is exerted also on the electric-power conversion apparatus 100 to be mounted in the vehicle. Even when undergoing a vibration environment, the electric-power conversion apparatus 100 according to Embodiment 1 can suppress substrate bending due to the vibration so as to prevent it that stress exerted on the substrate itself or the connection portion between the substrate and the control-terminal group of a semiconductor module, and the like becomes large and breaks the substrate.

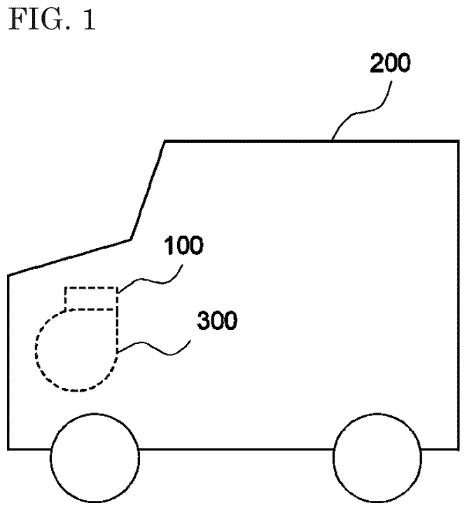

Hereinafter, an installation example of the electric-power conversion apparatus 100 according to Embodiment 1 will be explained by use of FIG. 1.

FIG. 1 is a view illustrating an example of the installation state of the electric-power conversion apparatus 100 according to Embodiment 1.

The electric-power conversion apparatus 100 is mounted in a vehicle 200 and supplies a motor 300 of the vehicle with electric power supplied from a power source, while converting the voltage, the current, the frequency (including also the direct current having zero frequency), and the like. The motor 300 is a three-phase motor. The electric-power conversion apparatus 100 is fixed to the motor 300 as one example of vehicle power train apparatuses.

In the present embodiment, the vehicle power train apparatus is an apparatus that is mounted in a vehicle and functions so as to drive or brake the wheels of the vehicle; for example, the vehicle power train apparatus is a prime mover such as a motor or an engine, a driving power transfer unit such as a transmission for transferring driving power generated by the prime mover to the wheels of the vehicle or a driving shaft, a power generator for converting kinetic energy of rotation of the prime mover or the wheel of the vehicle into electric energy, or a motor generator having the functions of both the motor and the power generator.

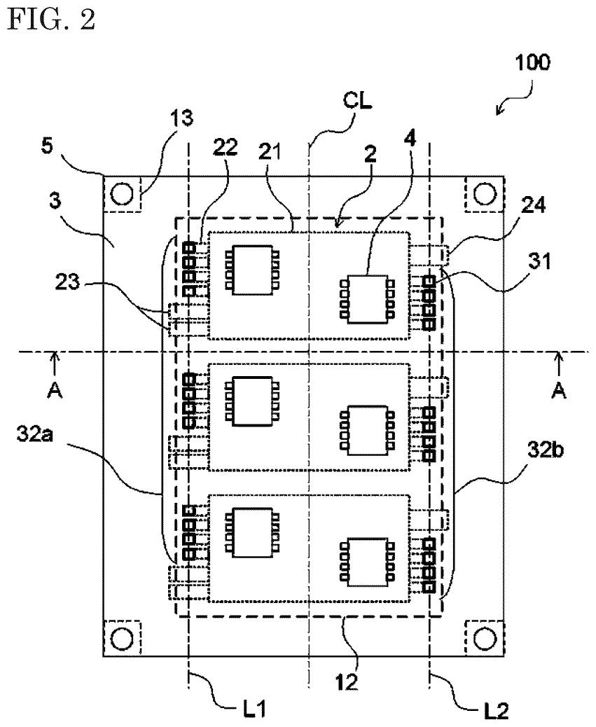

Hereinafter, the configuration of the electric-power conversion apparatus 100 according to Embodiment 1 will be explained by use of FIGS. 2, 3, 4, 5, 6, and 7.

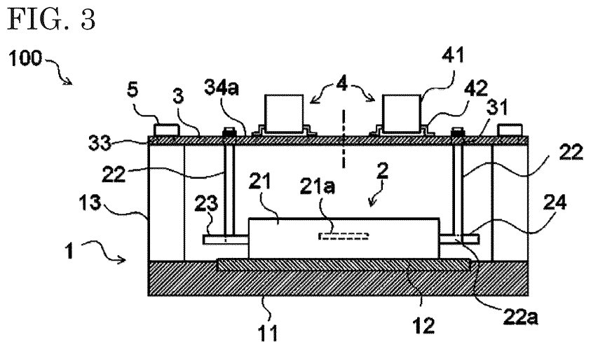

FIG. 2 is a top view of the electric-power conversion apparatus 100 according to Embodiment 1, and FIG. 3 is a cross-sectional view of the electric-power conversion apparatus 100, taken along the line A-A; the electric-power conversion apparatus 100 has a case 1, a substrate 3 fixed by a fixation member 5 to a boss portion 13 provided in the case 1, and a semiconductor module 2 having a main body portion 21 that is fixed to a bottom portion 11 of the case 1 through the intermediary of a cooling device 12 such as a heat sink and two or more control terminals 22 that are pulled out from the main body portion 21; in the substrate 3, a connection portion 32a and a connection portion 32b, to each of which the two or more control terminals 22 of the semiconductor module 2 are fixed in substantially linear alignment, are arranged in substantially parallel with the alignment direction and in such a way as to face each other.

The substrate 3 is provided with transformer 4, as mounting components, each of which is mounted at a position avoiding a virtual center line CL—the respective distances from the virtual center line CL to the facing connection portions 32a and 32b are equal to each other—, and each of the gravity center of which is apart from the mounting surface of the substrate 3 in the normal direction.

In order to supply electric power to the motor 300, which is a three-phase motor, the electric-power conversion apparatus 100 has three semiconductor modules 2 corresponding to the respective phases. The main body portion 21 of the semiconductor module 2 is configured in such a way that the switching device 21a to be utilized for electric-power conversion is sealed through molding utilizing a sealing resin. This sealing resin is a thermosetting resin such as an epoxy resin. As the switching device 21a, for example, a semiconductor device such as a MOSFET (Metal Oxide Semiconductor Field Effect Transistor) having three kinds of electrodes, i.e., a gate, a drain, and a source, or an IGBT (Insulated Gate Bipolar Transistor) having three kinds of electrodes, i.e., a gate, a collector, and an emitter is utilized.

Then, this main body portion 21 is firmly fixed to the cooling device 12 through soldering in such a way that the bottom surface thereof is adhered to the cooling device 12, so that the main body portion 21 is held to the bottom portion 11 of the case 1.

Each of the two or more control terminals 22 of the semiconductor module 2 is fixed to the main body portion 21 in such a way that one end thereof is electrically connected with the switching device 21a inside the main body portion 21 and in such a way that through molding, part thereof is sealed by a sealing resin. The other end of the control terminal 22 is pulled out from each corresponding one of the two side surfaces of the main body portion 21 and is exposed to the outside of the main body portion 21. In this situation, “pulled out” denotes the state where the control terminal 22 extends from the inside to the outside of the main body portion 21 and the other end thereof is exposed to the outside.

The control terminal 22 has a bent portion 22a at a portion thereof exposed from the main body portion 21 and has a front-end portion, at the front end thereof, that is formed in a pin shape. The bent portion 22a is formed through press working utilizing a bending die. It is desirable that the thickness of the control terminal 22 is set to be the same as or smaller than 1 mm, in order to suppress abrasion of the die at a time of press working of the bent portion 22a. The heat sink 22 is made of a conductive material such as copper or aluminum.

In addition, the semiconductor module 2 has an input terminal 23 for inputting electric power from a power source such as a battery and an output terminal 24 for outputting electric power converted by the switching device 21a thereinside. Each of the input terminal 23 and the output terminal 24 is fixed to the main body portion 21 in such a way that one end thereof is electrically connected with the switching device 21a inside the main body portion 21 and in such a way that through molding, part thereof is sealed by a sealing resin. The other end of each of the input terminal 23 and the output terminal 24 is pulled out from each corresponding one of the two side surfaces of the main body portion 21 and is exposed to the outside of the main body portion 21.

The substrate 3 is formed in the shape of a plate in such a way that two or more insulating layers each utilizing an insulating material such as glass epoxy or a ceramic material and two or more wiring layers each utilizing a conductive material such as copper are alternately stacked on each other. A supported portion 33 forming a hole is provided at an outer-edge portion of the substrate 3; the supported portion 33 is fixed to the boss portion 13 by a fixation member 5 such as a screw. On the substrate 3, there are configured the connection portion 32a formed in such a way that two or more through-holes 31 are aligned along a virtual straight line L1 (a first line) on the surface of the substrate 3 and the connection portion 32b formed in such a way that two or more through-holes 31 are aligned along a virtual straight line L2 (a second line) parallel to the virtual straight line L1. The pin-shaped front-end portion of the control terminal 22 is inserted into and soldered to the through-hole 31 of each corresponding one of the connection portions 32a and 32b, and then is adhered to the substrate 3 because solder is filled in the through-hole 31; thus, the control terminal 22 and the substrate 3 are adhered to and electrically connected with each other.

In addition, the substrate 3 has no supported portion, such as a through-hole for a screw, with which the substrate 3 is fixed to the case 1 or the semiconductor module 2, in the area between the connection portion 32a and the connection portion 32b, when viewed from thereabove.

The transformer 4, which is one example of the mounting components to be mounted on the substrate 3 has a transformer main portion 41 and leads 42 to be pulled out from the side surfaces of the transformer main portion 41. The leads 42 are mounted on a first mounting surface 34a of the substrate 3 so as to be fixed to the substrate 3 and are electrically connected with the wiring layers of the substrate 3, so that the transformer 4 is mounted on the substrate 3. In the present embodiment, “mounting surface” denotes the surface of the substrate 3, on which the transformer 4 as a mounting component is mounted.

As illustrated in FIG. 2, the transformers 4 are mounted at respective positions avoiding the virtual center line CL, within an area inserted between the virtual straight line L1 and the virtual straight line L2, when the first mounting surface 34a is viewed from thereabove. In addition, the transformers 4 are arranged in a zigzag manner across the virtual center line CL.

The transformer 4 is a so-called tall component; the height of the gravity center of the transformer 4 from the first mounting surface 34a is larger than the height of any other component (unillustrated) to be mounted in the area inserted between the virtual straight line L1 and the virtual straight line L2.

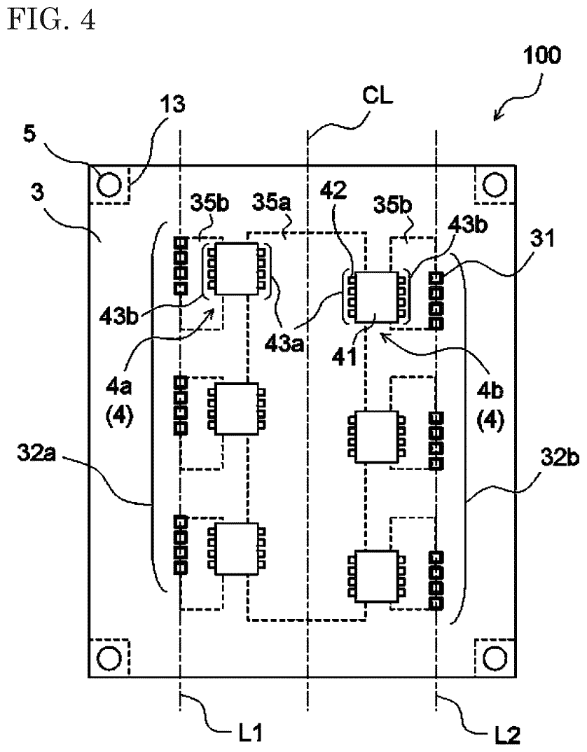

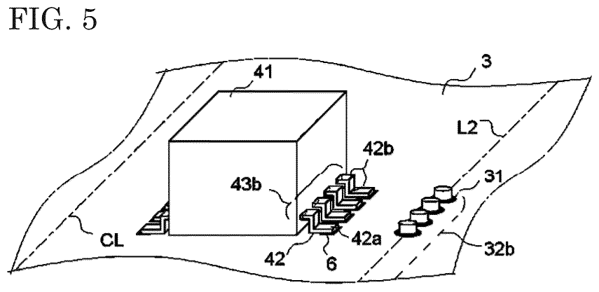

FIG. 4 is a top view illustrating a circuit configured on the substrate 3 of the electric-power conversion apparatus 100 according to Embodiment 1. FIG. 5 is a perspective view illustrating the mounting portion between the substrate 3 and the transformer 4 of the electric-power conversion apparatus 100 according to Embodiment 1. As illustrated in FIG. 4, each of the transformers 4a and 4b has a lead group 43a and a lead group 43b, in each of which two or more leads 42 are pulled out in linear alignment. The lead group 43a and the lead group 43b of each of the transformers 4a and 4b are pulled out in an opposing manner. The lead group 43b of the transformer 4a is pulled out from the side surface of the transformer main portion 41 at the connection portion 32a side, when the substrate 3 is viewed from thereabove. The lead group 43b of the transformer 4b is pulled out from the side surface of the transformer main portion 41 at the connection portion 32b side, when the substrate 3 is viewed thereabove. In addition, a circuit 35a and circuits 35b are configured on the substrate 3. Each of the lead groups 43b of the transformer 4a and the transformer 4b arranged in a zigzag manner across the virtual center line CL is connected with the circuit 35a disposed on the virtual center line CL. In addition, each of the respective lead groups 43b of the transformer 4a and the transformer 4b is connected with the corresponding circuit 35b.

As described above, the circuit 35a is electrically connected with each of the respective lead groups 43a of the transformer 4a and the transformer 4b, and the circuit 35b is electrically connected with the lead group 43b of the transformer 4a in the connection portion 32a or the lead group 43b of the transformer 4b in the connection portion 32b, so that the control circuit of the substrate 3 that controls the semiconductor module 2 is configured.

Three pieces each of the transformer 4a and the transformer 4b are arranged on the substrate 3; each of the transformers 4a and the transformers 4b is electrically connected with the corresponding semiconductor module 2 by way of the circuit 35b. Each of these six transformers 4a and 4b has one and the same shape and one and the same specification and is disposed at its position avoiding the virtual center line CL.

As illustrated in FIG. 5, the lead 42 is in the shape of a belt having a flat cross section in the direction of pulling out from the transformer main portion 41; the leads 42 are pulled out from the side surface of the transformer main portion 41 in such a way the alignment direction thereof is a transverse direction. In addition, each of the two or more leads 42 of the transformer 4 has a lead bending portion 42b in a section from the position at which it is pulled out from the transformer main portion 41 to a lead front-end portion 42a. In addition, the transformer 4 is a mounting component to be mounted on the substrate 3 through so-called surface mounting; the lead front-end portion 42a is adhered to the first mounting surface 34a of the substrate 3 through soldering in such a way as to be parallelly in contact with the first mounting surface 34a.

An adhesion portion 6 where the lead group 43a and the substrate 3 are adhered to each other and an adhesion portion 6 where the lead group 43b and the substrate 3 are adhered to each other face each other on the mounting surface of the substrate 3; the facing direction coincides with the direction in which the connection portion 32a and the connection portion 32b face each other. In addition, each of the adhesion portions 6 is disposed outside the transformer main portion 41, when the substrate 3 is viewed.

In addition, the respective adhesion portions 6 between the two or more lead front-end portions 42a of the lead groups 43a and 43b and the substrate 3 are aligned in parallel with the alignment directions of the respective through-holes 31 in the connection portion 32a and the connection portion 32b, i.e., L1 and L2.

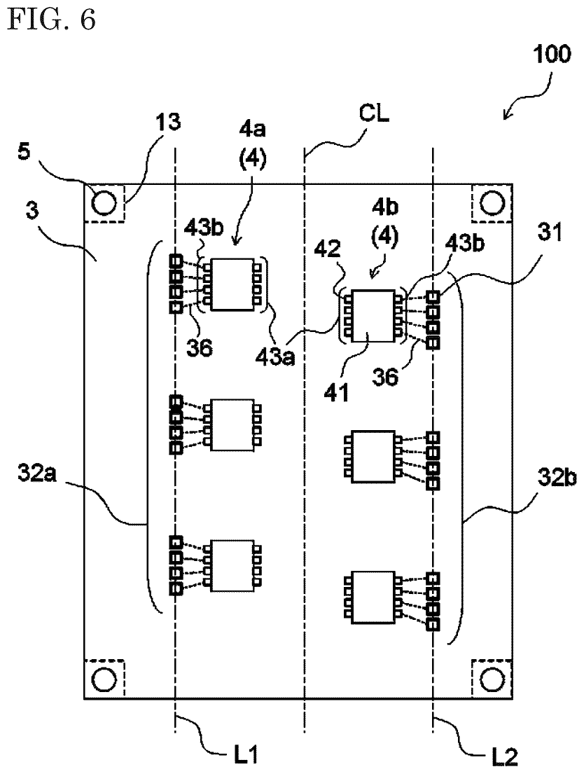

FIG. 6 is a top view illustrating part of a wiring layer inside the substrate 3 of the electric-power conversion apparatus 100 according to Embodiment 1. As illustrated in FIG. 6, wiring strip conductors 36 for electrically connecting the lead group 43b with the connection portion 32a or 32b are configured on the wiring layer inside the substrate 3. The wiring strip conductors 36 form part of the circuit 35b.

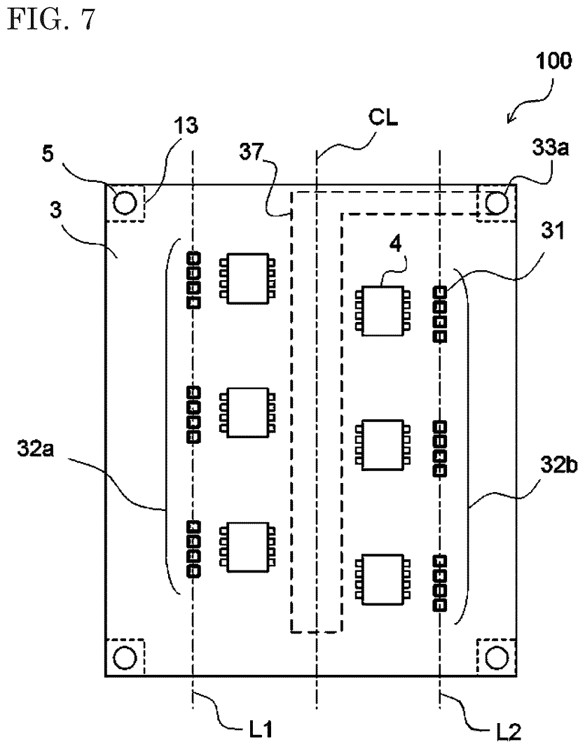

FIG. 7 is a top view illustrating the position of a ground strip conductor 37 provided on the substrate 3 of the electric-power conversion apparatus 100 according to Embodiment 1; FIG. 7 illustrates the ground strip conductor 37 by use of a dotted line. The ground strip conductor 37 is made of metal, which is a conductive material positioned within the substrate 3; in general, the ground strip conductor 37 is wider than any other wiring strip conductor to be formed on the substrate 3. As illustrated in FIG. 7, the ground strip conductor 37 is positioned in such a way as to overlap with the virtual center line CL, when the substrate 3 is viewed from thereabove; one end thereof is connected with a grounding portion 33a formed at the supported portion 33 and becomes conductive to the boss portion 13, so that the ground strip conductor 37 has an electric potential the same as that of the case 1.

Next, the operation in the electric-power conversion apparatus 100 configured as described above will be explained.

The electric-power conversion apparatus 100 converts the voltage, the current, the frequency (including also the direct current having zero frequency), and the like of electric power inputted from a power source such as a battery through the input terminal 23 of the semiconductor module 2, by making the switching device 21a in the main body portion 21 of each of the semiconductor modules 2 perform switching operation, and then, supplies suitable electric power to the motor 300 of the vehicle 200 through the output terminal 24. The three semiconductor modules 2 supply electric power to the respective phases of the motor 300, which is a three-phase motor; one of the semiconductor modules 2 supplies electric power to the corresponding one phase. Transfer of a driving signal outputted by the substrate 3 through the control terminal 22 controls the electric power to be outputted by each of the semiconductor modules 2.

In this situation, because when the vehicle 200 travels, vibration occurs therein, the vibration is exerted also on the electric-power conversion apparatus 100 to be mounted in the vehicle 200; then, the vibration is transferred to the substrate 3 of the electric-power conversion apparatus 100. In addition, when in order to drive the wheels of the vehicle 200, the motor 300 rotates, vibration corresponding to the rotation speed occurs; the vibration is transferred also to the electric-power conversion apparatus 100 to be fixed to the motor 300. When surface-direction vibration is exerted on the substrate 3, inertial force occurs in the transformer 4; because respective different-direction forces are exerted on the transformer 4 and the substrate 3, the head-top portion of the transformer main portion 41 vibrates as if a pendulum. Due to the vibration of the transformer 4, normal-direction force is exerted on the substrate 3 through the mounting position where the lead 42 is mounted on the substrate 3; thus, vibration that bends the substrate 3 in the normal direction occurs.

With regard to the mounting components to be mounted on the substrate 3, the inertial force to be exerted on a mounting component becomes large in proportion to the height of the gravity center of the mounting component from the first mounting surface 34, and the vibration that is caused by the inertial force and bends the substrate in the normal direction thereof also becomes large. The transformer 4 is a so-called tall component; because the height of the gravity center of the transformer 4 from the first mounting surface 34a is large, vibration that bends the substrate 3 in the normal direction thereof is liable to become large.

In addition, in the case where when a mounting component is mounted on the substrate 3, the mounting component is disposed at a position that is located between and apart from the connection portion 32a and the connection portion 32b, i.e., at a position close to the virtual center line CL, the respective distances from which to the facing connection portion 32a and the connection portion 32b are equal to each other, the vibration that bends the substrate 3 in the normal direction thereof becomes large, in comparison with the case where the mounting component is disposed at any other position.

In the electric-power conversion apparatus 100 according to Embodiment 1, because the transformer 4 that has a high gravity center and makes the vibration of the substrate 3 liable to become large is mounted at a position avoiding the virtual center line CL where the bending of the substrate 3 becomes large, it is made possible to suppress the bending of the substrate 3 at a time when vibration that bends the substrate 3 in the normal direction thereof occurs, in comparison with the case where the transformer 4 is mounted on the virtual center line CL of the substrate 3. Accordingly, it is made possible to increase the frequency of the resonance that is caused to occur in the substrate 3 by surface-direction vibration exerted on the substrate 3 and that has its nodes at the connection portions 32a and 32b and its loop in the area sandwiched between the connection portions 32a and 32b; moreover, when the resonance occurs, it is made possible to suppress the amplitude of the displacement in the normal direction of the substrate 3.

In addition, in general, among the mounting components to be mounted on the substrate 3, the weight of the transformer 4 is relatively large. In the electric-power conversion apparatus 100 according to Embodiment 1, because the transformer 4 whose weight is relatively large is mounted at a position avoiding the virtual center line CL where the bending of the substrate 3 becomes large, it is made possible to suppress the normal-direction bending of the substrate 3 that occurs when normal-direction vibration is exerted on the substrate 3, in comparison with the case where the transformer 4 is mounted on the virtual center line CL of the substrate 3.

Accordingly, it is made possible to increase the frequency of the resonance that is caused to occur in the substrate 3 by vibration exerted on the substrate 3 and that has its nodes at the connection portions 32a and 32b and its loop in the area sandwiched between the connection portions 32a and 32b; moreover, when the resonance occurs, it is made possible to suppress the amplitude of the displacement in the normal direction of the substrate 3.

As described above, in the electric-power conversion apparatus 100 according to Embodiment 1, the connection portions 32a and 32b, to which the corresponding control terminals 22 of the semiconductor modules 2 are adhered, face each other, and the transformers 4 as mounting components are arranged at the respective positions avoiding the virtual center line CL, the respective distances from which to the facing connection portions 32a and 32b are equal to each other; therefore, it is made possible to increase the frequency of the resonance that is caused to occur in the substrate 3 by vibration exerted on the substrate 3 and that has its nodes at the connection portions 32a and 32b and its loop in the area sandwiched between the connection portions 32a and 32b; moreover, when the resonance occurs, it is made possible to suppress the amplitude of the displacement in the normal direction of the substrate 3.

In addition, a vehicle power train apparatus to be mounted in the vehicle 200 is a vibration generation source that vibrates when driving or braking the wheels of the vehicle.

The electric-power conversion apparatus 100 according to Embodiment 1 can suppress bending of the substrate 3, even when being fixed to the vehicle power train apparatus, which is a vibration generation source.

In addition, in the electric-power conversion apparatus 100 according to Embodiment 1, because the transformer 4 is mounted in an area sandwiched between the virtual straight line L1 where the connection portion 32a of the substrate 3 are arranged and the virtual straight line L2 where the connection portion 32b are arranged, the area where the circuit 35a, with which the lead groups 43a are connected, is arranged and the areas where the respective circuits 35b, with each of which the connection portion 32a or 32b and the lead group 43b are connected, are arranged can be reduced, in comparison with the case where the transformer 4 is mounted outside the area sandwiched between the virtual straight line L1 and the virtual straight line L2; moreover, the wiring strip conductors to be formed in the circuits 35a and 35b can be shortened more. As a result, the substrate 3 can be downsized, and the controllability, of the switching device 21a in the semiconductor module 2, by the substrate 3 can be enhanced. However, when the transformer 4 having a large weight among the mounting components is mounted in the area sandwiched between the virtual straight line L1 and the virtual straight line L2, the bending of the area sandwiched between the virtual straight line L1 and the virtual straight line L2 becomes large, in comparison with the case where the transformer 4 is mounted outside the area sandwiched between the virtual straight line L1 and the virtual straight line L2; thus, the resonance that is caused to occur in the substrate 3 by vibration exerted on the substrate 3 and that has its nodes at the connection portions 32a and 32b and its loop in the area sandwiched between the connection portions 32a and 32b is liable to occur; moreover, when the resonance occurs, the amplitude of the displacement in the normal direction of the substrate 3 is liable to become large. However, in the electric-power conversion apparatus 100 according to Embodiment 1, it is made possible to suppress the bending of the substrate 3 at a time when, as described above, vibration occurs in the substrate 3; therefore, the substrate 3 can be downsized, and the controllability, of the switching device 21a in the semiconductor module 2, by the substrate 3 can be enhanced.

In this situation, in the case where a component having the largest weight among the components to be mounted in the area sandwiched between the virtual straight line L1 and the virtual straight line L2 is mounted on the substrate 3 avoiding the virtual center line CL, it is made possible to increase the frequency of the resonance, in the electric-power conversion apparatus 100 according to Embodiment 1, that is caused to occur in the substrate 3 by vibration exerted on the substrate 3 and that has its nodes at the connection portions 32a and 32b and its loop in the area sandwiched between the connection portions 32a and 32b; moreover, when the resonance occurs, it is made possible to demonstrate most the effect that the amplitude of the displacement in the normal direction of the substrate 3 can be suppressed.

Moreover, even when being configured in such a way that, when the substrate 3 is viewed from thereabove, the supported portion is not provided in an area sandwiched between the connection portions 32a and 32b, the electric-power conversion apparatus 100 according to Embodiment 1 can suppress the bending of the substrate 3 at a time when vibration occurs in the substrate 3, as described above; thus, it is made possible to suppress the substrate 3 from upsizing and the cost from increasing.

In addition, because in the electric-power conversion apparatus 100 according to Embodiment 1, the adhesion between the control terminal 22 and the connection portion 32a or 32b of the substrate 3 is performed through soldering, it is made possible to downsize the substrate 3, in comparison with the adhesion through screw fastening or by use of a connector. However, in the case of the adhesion between the control terminal 22 and the substrate 3 through soldering, when vibration occurs in the substrate 3, the substrate is bent; therefore, stress exerted on the soldering portions of the connection portions 32a and 32b may peel off the solder. However, the electric-power conversion apparatus 100 according to Embodiment 1 can suppress the bending of the substrate 3 at a time when, as described above, vibration occurs in the substrate 3; thus, it is made possible to suppress the solder at the connection portions 32a and 32b from being peeled off, when vibration occurs in the substrate 3.

Moreover, in the electric-power conversion apparatus 100 according to Embodiment 1, the respective groups of the through-holes 31 in the connection portions 32a and 32b of the substrate 3 are aligned along the straight line L1 and L2; thus, the process of adhering the control terminals 22 to the through-holes 31 can be performed through flow soldering. Accordingly, the process of adhering the two or more control terminals 22 to the through-holes 31 can be performed at one time; thus, it is made possible to shorten the working time, in comparison with the case where the respective groups of the through-holes 31 in the connection portions 32a and 32b are not linearly aligned.

In addition, in the electric-power conversion apparatus 100 according to Embodiment 1, the substrate 3 has no supported portion, such as a through-hole for a screw, with which the substrate 3 is fixed to the case 1 or the semiconductor module 2, in the area between the connection portion 32a and the connection portion 32b, when viewed from thereabove. Accordingly, the circuit 35a and 35b can efficiently be formed in the area sandwiched between the connection portion 32a and the connection portion 32b of the substrate 3; thus, the substrate 3 can be downsized. However, in the case where, as described above, no supported portion is provided in the area sandwiched between the connection portion 32a and the connection portion 32b, when the substrate 3 is viewed from thereabove, the bending in the area sandwiched between the connection portion 32a and the connection portion 32b is liable to become large. However, in the electric-power conversion apparatus 100 according to Embodiment 1, as described above, it is made possible to suppress the bending of the substrate 3 at a time when vibration occurs in the substrate 3; thus, even in the case where, when the substrate 3 is viewed from thereabove, the supported portion is not provided in the area sandwiched between the connection portions 32a and 32b, it is made possible to increase the frequency of the resonance that is caused to occur in the substrate 3 by vibration exerted on the substrate 3 and that has its nodes at the connection portions 32a and 32b and its loop in the area sandwiched between the connection portions 32a and 32b; moreover, when the resonance occurs, it is made possible to suppress the amplitude of the displacement in the normal direction of the substrate 3.

Moreover, in the electric-power conversion apparatus 100 according to Embodiment 1, the control terminal 22 has the bent portion 22a in the portion thereof exposed from the main body portion 21; thus, because when the substrate 3 is bent, the bent portion 22a of the control terminal 22 elastically deforms, it is made possible to suppress the stress that occurs in the control terminal 22 and to prevent the control terminal 22 from being broken.

In addition, in the electric-power conversion apparatus 100 according to Embodiment 1, the control terminal 22 is integrated with the switching device 21a of the main body portion 21 through molding utilizing a sealing resin. In the case where the semiconductor module 2 is produced through molding, it is made possible to shorten the manufacturing process, in comparison with a case-type semiconductor module produced in such a way that a switching device, an input terminal, an output terminal, and a control terminal are arranged inside a resin-made case and then a resin material is filled into the case; thus, the cost of mass production can be suppressed. However, the semiconductor module 2 produced through molding requires a die for molding, and in the case where a change in the shape, such as a change in the shape of the control terminal 22 or in the position thereof is made, it is required to reproduce the die; thus, the cost of the semiconductor module 2 increases, in comparison with the foregoing case-type semiconductor module. Accordingly, in comparison with a case-type semiconductor module produced by filling a resin material into a case, the semiconductor module 2 has a difficulty in changing, due to a change in the specification of the substrate 3, the shape or the position of the control terminal 22 in order to secure the strength of the substrate 3 or the control terminal 22. However, the electric-power conversion apparatus 100 according to Embodiment 1 can suppress the bending of the substrate 3 at a time when, as described above, vibration occurs in the substrate 3; thus, it is made possible to produce the semiconductor module 2 through molding, while preventing occurrence of the necessity that in order to secure the strength of the substrate 3 or the control terminal 22, the shape or the position of the control terminal 22 is changed; therefore, the manufacturing process can be shortened and hence the cost of mass production can be suppressed.

In addition, the sealing resin for the main body portion 21 of the semiconductor module 2 is a thermosetting resin such as an epoxy resin. A thermosetting resin has mechanical strength larger than that of a thermoplastic resin. Accordingly, the control terminal 22 and the switching device 21a of the semiconductor module 2 can more robustly be integrated with each other. However, the shock resistance of a thermosetting resin is inferior to that of a thermoplastic resin; thus, when vibration occurs in the substrate 3 and the shock is transferred to the sealing resin for the main body portion 21, through the control terminal 22, a crack is liable to occur in the sealing resin. However, because the configuration according to Embodiment 1 makes resonance hardly occur when vibration occurs in the substrate 3, it is made possible to suppress the shock that is exerted on the sealing resin for the main body portion 21, through the control terminal 22, and hence it is made possible to prevent a crack from occurring in the sealing resin for the main body portion 21.

Moreover, in the electric-power conversion apparatus 100 according to Embodiment 1, the transformer 4 is mounted on the first mounting surface 34a, of the substrate 3, that is reverse to the surface facing the main body portion 21 of the semiconductor module 2. Accordingly, it is made possible to shorten the control terminal 22 of the semiconductor module 2 so as to enhance the rigidity of the control terminal 22; thus, the stress that occurs in the control terminal 22 when the substrate 3 deforms can be suppressed.

In addition, in the electric-power conversion apparatus 100 according to Embodiment 1, the transformers 4 are arranged in a zigzag manner across the virtual center line CL. Accordingly, the places on each of which the weight of the transformer 4, as a mounting component, is exerted can be decentralized in the area sandwiched between the connection portion 32a and the connection portion 32b of the substrate 3; thus, it is made possible to suppress the normal-direction bending of the substrate 3.

In addition, in the electric-power conversion apparatus 100 according to Embodiment 1, the lead group 43b of the transformer 4a is pulled out from the transformer main portion 41 at the connection portion 32a side, when the substrate 3 is viewed from thereabove; the lead group 43b of the transformer 4b is pulled out from the transformer main portion 41 at the connection portion 32b side, when the substrate 3 is viewed from thereabove. Accordingly, because it is made possible to shorten the respective wiring strip conductors 36 that electrically connect the lead group 43b of the transformer 4 with the connection portion 32a or the connection portion 32b, in comparison with the case where the lead group 43b is pulled out from the transformer main portion 41 at the other side, the controllability, of the switching device 21a in the semiconductor module 2, by the substrate 3 can be enhanced.

Moreover, in the electric-power conversion apparatus 100 according to Embodiment 1, the respective groups of the two or more adhesion portions 6 between the leads 42 of the lead group 43b and the substrate 3 are aligned in parallel with the alignment direction of the through-holes 31 in the connection portion 32a or the connection portion 32b. Accordingly, because it is made possible to make the respective groups of the wiring strip conductors 36, which electrically connect the lead group 43b of the transformer 4 with the connection portion 32b, have more uniform lengths, in comparison with the case where the respective groups of the adhesion portions 6 between the lead group 43b and the substrate 3 are not aligned in parallel with the alignment direction of the through-holes 31 in the connection portion 32b, the controllability, of the switching device 21a in the semiconductor module 2, by the substrate 3 can be enhanced.

Moreover, in the electric-power conversion apparatus 100 according to Embodiment 1, the opposing direction in which the lead group 43a and the lead group 43b of the transformer 4 face each other coincides with the opposing direction in which the connection portion 32a and the connection portion 32b of the substrate 3 face each other. Accordingly, it is made possible to downsize the circuits 35a 35b, in comparison with the case where the opposing direction in which the lead group 43a and the lead group 43b of the transformer 4 face each other does not coincide with the opposing direction in which the connection portion 32a and the connection portion 32b of the substrate 3 face each other, for example, the respective opposing directions are perpendicular to each other.

In addition, in the electric-power conversion apparatus 100 according to Embodiment 1, the lead group 43a and the lead group 43b of the transformer 4 are pulled out from the transformer main portion 41 in an opposing manner, and are each adhered to the substrate 3. Accordingly, the transformer 4 more hardly falls down in the opposing direction in which the lead group 43a and the lead group 43b face each other than in any other direction.

In the case where vibration in the substrate 3 causes bending to occur in the substrate 3, the normal-direction displacement of the substrate 3 becomes larger on the virtual center line CL, the respective distances from which to the connection portions 32a and 32b are equal to each other, than at each of the connection portions 32a and 32b that are held to the semiconductor module 2; thus, the normal-direction displacement, of the substrate 3, on the virtual center line CL is different from the normal-direction displacement, of the substrate 3, on each of the virtual straight lines L1 and L2. When such vibrations having different normal-direction displacements occur, there occurs a vibration that makes the transformer 4, positioned between the virtual center line CL and the virtual straight line L1 or the virtual straight line L2, fall down in the opposing direction in which the connection portions 32a and 32b face each other. The falling of the transformer 4 may cause stress to occur in the solder adhering the transformer 4 or the lead front-end portion 42a to the substrate 3, and hence the substrate 3 may be broken.

However, in the electric-power conversion apparatus 100 according to Embodiment 1, because the opposing direction in which the lead groups 43a and 43b face each other coincides with the opposing direction in which the connection portions 32a and 32b face each other, the transformer 4 hardly falls down even when there occurs bending in which the respective displacements, in the normal direction of the substrate 3, on the virtual straight line L1 or L2 and on the virtual center line CL differ from each other, in comparison with the case where the opposing direction in which the lead groups 43a and 43b face each other does not coincide with the opposing direction in which the connection portion 32a and the connection portion 32b of the substrate 3 face each other. Therefore, when vibration occurs in the substrate 3, it is made possible to suppress stress that occurs in the solder adhering the transformer 4 or the lead front-end portion 42a to the substrate 3 and to prevent the substrate 3 from being broken.

In addition, the transformer 4 is a mounting component to be mounted on the substrate 3 through so-called surface mounting; the lead front-end portion 42a is adhered to the first mounting surface 34a of the substrate 3 in such a way as to be in contact with and in parallel with the mounting surface 34a; each of the adhesion portions 6 is disposed outside the transformer main portion 41, when the substrate 3 is viewed. Accordingly, the distance between the facing lead groups 43a and 43b becomes large, in comparison with the case where, when the substrate 3 is viewed from thereabove, each of the adhesion portions 6 is located inside the transformer main portion 41; thus, the transformer 4 more hardly falls down.

In addition, the lead front-end portions 42a and the adhesion portions 6 of the substrate 3 are arranged outside the transformer main portion 41, when the substrate 3 is viewed from thereabove; thus, because in a soldering process, a machine tool or a jig for soldering can be applied thereto from above the mounting surface, the soldering process can readily be performed.

Moreover, in the electric-power conversion apparatus 100 according to Embodiment 1, the lead 42 of the transformer 4 has the lead bending portion 42b. Therefore, when vibration occurs in the substrate 3 and the transformer 4 vibrates, the lead bending portion 42b elastically deforms, so that it is made possible to suppress stress to be exerted on the solder adhering the lead front-end portion 42a to the substrate 3 and to prevent the solder from being peeled off.

In addition, in the electric-power conversion apparatus 100 according to Embodiment 1, the ground strip conductor 37 is disposed on the virtual center line CL of the substrate 3. Because the ground strip conductor 37 is wider than any other wiring strip conductor of the substrate 3 and the ground strip conductor 37 made of wide metal is disposed on the virtual center line CL, the bending rigidity of the area sandwiched between the virtual straight line L1 and the virtual straight line L2 of the substrate 3 is raised; thus, it is made to suppress bending caused by the weight of a component to be mounted in the area sandwiched between the virtual straight line L1 and the virtual straight line L2 of the substrate 3.

### Embodiment 2

In Embodiment 1, there has been explained the case where the transformer 4 as a mounting component is mounted on the first mounting surface 34a, of the substrate 3, that is reverse to the surface facing the main body portion 21 of the semiconductor module 2 of the substrate 3; however, the transformer 4 as a mounting component may be mounted on a second mounting surface 34b, of the substrate 3, that faces the main body portion 21 of the semiconductor module 2.

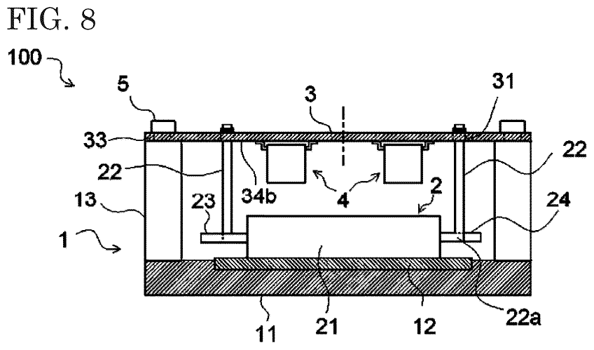

FIG. 8 is a cross-sectional view of an electric-power conversion apparatus 100 according to Embodiment 2; in FIG. 8, each of the transformers 4 as mounting components is mounted at the position, in the substrate 3, that is on the second mounting surface 34b facing the main body portion 21 of the semiconductor module 2 and that avoids the virtual center line CL.

Also in this case, as is the case with Embodiment 1, it is made possible to increase the frequency of the resonance that is caused to occur in the substrate 3 by vibration exerted on the substrate 3 and that has its nodes at the connection portions 32a and 32b and its loop in the area sandwiched between the connection portions 32a and 32b; moreover, when the resonance occurs, it is made possible to suppress the amplitude of the displacement in the normal direction of the substrate 3.

Moreover, in the electric-power conversion apparatus 100 according to Embodiment 2, the transformer 4 is mounted on the second mounting surface 34b, of the substrate 3, that faces the main body portion 21 of the semiconductor module 2. In this case, because each of the transformers 4 as tall components is arranged in the space between the substrate 3 and the main body portion 21 of the semiconductor module 2, it is made possible to suppress the respective heights from the main body portion 21 of the semiconductor module 2 to the substrate 3 and from the main body portion 21 to the transformer 4 as a mounting component; therefore, the electric-power conversion apparatus 100 can be downsized.₈

### Embodiment 3

In Embodiment 1, the respective groups of the control terminals 22 pulled out from the semiconductor module 2 are adhered to the facing connection portions 32a and 32b of the substrate 32; however, the respective groups of the control terminals 22 of the different semiconductor modules 2 may be adhered to the connection portion 32a and the connection portion 32b.

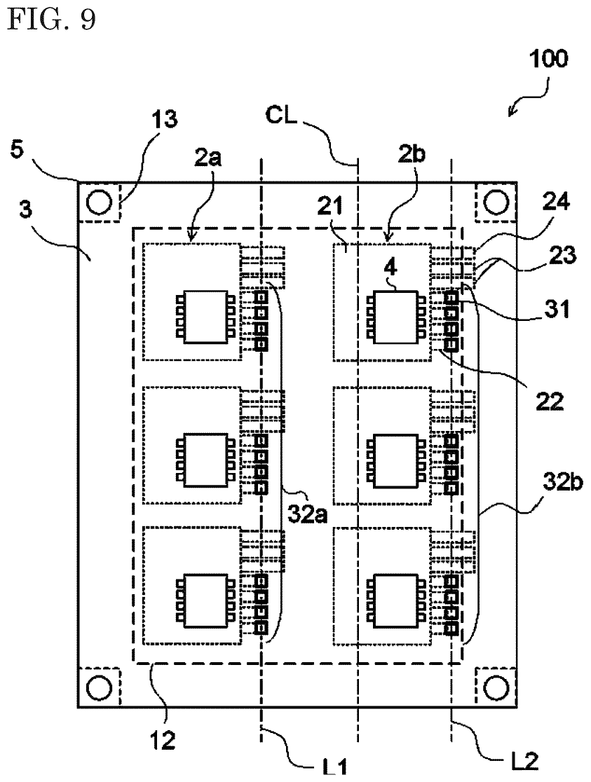

FIG. 9 is a top view of an electric-power conversion apparatus 100 according to Embodiment 3; in FIG. 9, the control terminals 22 of the semiconductor module 2a are adhered to the connection portion 32a, and the control terminals 22 of the semiconductor module 2b are adhered to the connection portion 32b.

Also in this case, as is the case with Embodiment 1, it is made possible to increase the frequency of the resonance that is caused to occur in the substrate 3 by vibration exerted on the substrate 3 and that has its nodes at the connection portions 32a and 32b and its loop in the area sandwiched between the connection portions 32a and 32b; moreover, when the resonance occurs, it is made possible to suppress the amplitude of the displacement in the normal direction of the substrate 3.

### Embodiment 4

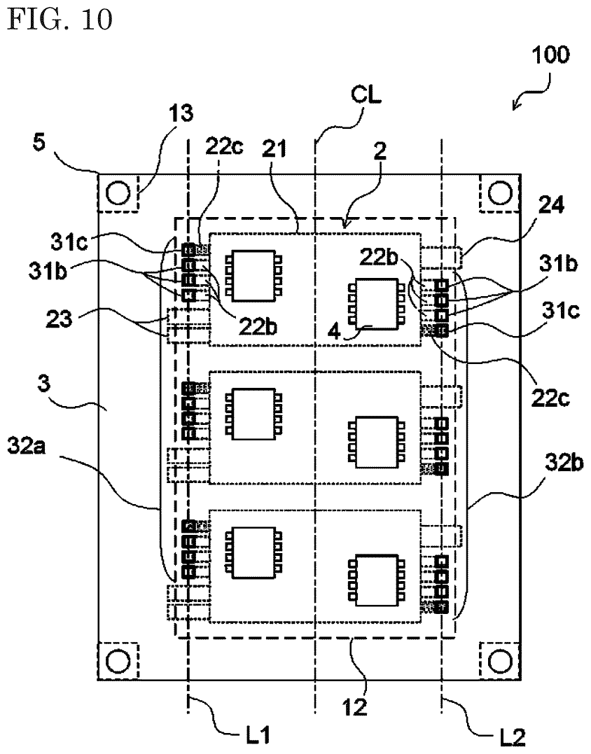

FIG. 10 is a top view of an electric-power conversion apparatus 100 according to Embodiment 4; in the electric-power conversion apparatus 100, control terminals 22b and control terminals 22c are pulled out from the main body portion 21 of the semiconductor module 2. One end of each of the control terminals 22b is electrically connected with the switching device 21a inside the main body portion 21, and the other end thereof is adhered to the through-hole 31b so as to hold the substrate 3; thus, the substrate 3 and the switching device 21a are electrically connected with each other. In contrast, the control terminals 22c are dummy terminals; one end of each thereof is electrically insulated from the switching device 21a inside the main body portion 21, and part of the control terminal 22c is sealed by a sealing resin so as to be fixed to the main body portion 21; thus, the control terminal 22c does not contribute to the electrical operation of the electric-power conversion apparatus 100. One end of each of the control terminals 22b is electrically connected with the switching device 21a inside the main body portion 21, and the other end thereof is adhered to the through-hole 31c so as to hold the substrate 3. The respective shapes of the portions, of the control terminal 22b and the control terminal 22c, exposed from the main body portion 21 are one and the same.

In the electric-power conversion apparatus 100 according to Embodiment 4, transfer of a driving signal outputted by the substrate 3 through the control terminal 22b controls the electric power to be outputted by the semiconductor modules 2 and to be supplied to the motor 300. Because the control terminal 22c is a dummy terminal and is insulated from the switching device 21a, the driving signal to be outputted from the substrate 3 is not transferred to the semiconductor module 2 through the control terminal 22c.

Also in this case, as is the case with Embodiment 1, it is made possible to increase the frequency of the resonance that is caused to occur in the substrate 3 by vibration exerted on the substrate 3 and that has its nodes at the connection portions 32a and 32b and its loop in the area sandwiched between the connection portions 32a and 32b; moreover, when the resonance occurs, it is made possible to suppress the amplitude of the displacement in the normal direction of the substrate 3.

Moreover, because in the electric-power conversion apparatus 100 according to Embodiment 4, the control terminal 22c holds the substrate 3 to the semiconductor module 2, the strength of fixation of the substrate 3 to the semiconductor module 2 can be enhanced, in comparison with the case where the control terminal 22 is not provided. Moreover, because the control terminal 22c is adhered to the through-hole 31c in the connection portion 32a or 32b through soldering, the adhesion process therefor can be performed through flow soldering, concurrently with the process in which the control terminal 22b is soldered to the through-hole 31b of the substrate 3; therefore, the working time can be shortened, in comparison with the case where the strength of fixation of the substrate 3 to the semiconductor module 2 is enhanced, for example, through a method of providing a boss for supporting the substrate 3 to the main body portion 21 of the semiconductor module 2.

Moreover, because the control terminal 22c is adhered to the through-hole 31c in the connection portion 32a or 32b, the strength of fixation of the substrate 3 to the semiconductor module 2 can be enhanced while the size of the substrate 3 is suppressed from increasing, in comparison with, for example, a method of providing a boss for supporting the substrate 3 to the main body portion 21 of the semiconductor module 2.

In addition, as a variant example of Embodiment 4, it may be allowed that in the electric-power conversion apparatus 100, the control terminal 22c is fixed to the main body portion 21 in such a way as to be electrically connected with the switching device 21a inside the main body portion 21 and in such a way that through molding, part thereof is sealed by a sealing resin, and the through-hole 31c with which the control terminal 22c is adhered to the substrate 3 is electrically insulated from the circuit 35a or the circuit 35b of the substrate 3.

Alternatively, it may be allowed that in the electric-power conversion apparatus 100, the control terminal 22c is fixed to the main body portion 21 in such a way as to be electrically insulated from the switching device 21a inside the main body portion 21 and in such a way that through molding, part thereof is sealed by a sealing resin, and the through-hole 31c with which the control terminal 22c is adhered to the substrate 3 is electrically insulated from the circuit 35a or the circuit 35b of the substrate 3.

Even in the case of the electric-power conversion apparatus 100, as a variant example of Embodiment 4, as is the case with the electric-power conversion apparatus 100 according to Embodiment 4, it is made possible to increase the frequency of the resonance that is caused to occur in the substrate 3 by vibration exerted on the substrate 3 and that has its nodes at the connection portions 32a and 32b and its loop in the area sandwiched between the connection portions 32a and 32b; moreover, when the resonance occurs, it is made possible to suppress the amplitude of the displacement in the normal direction of the substrate 3.

Still moreover, the strength of fixation of the substrate 3 to the semiconductor module 2 can be enhanced, while the working time for production thereof is suppressed or the size of the substrate 3 is suppressed from increasing.

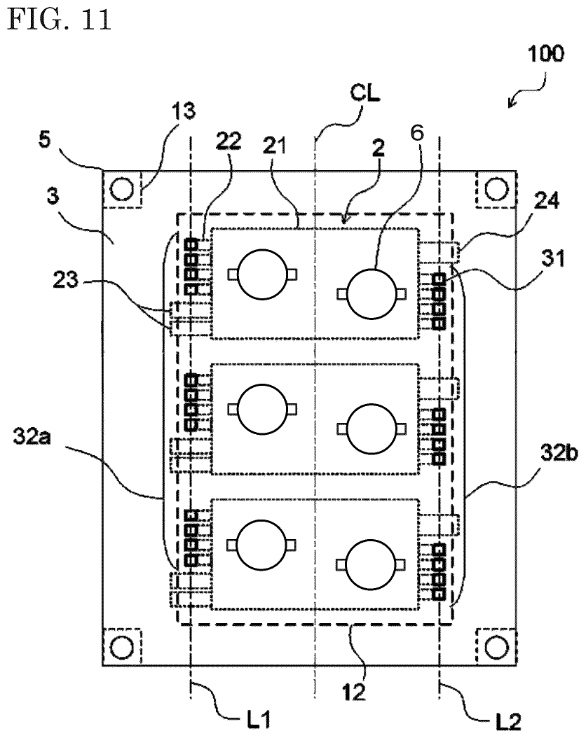

In addition, in each of foregoing Embodiments, there has been explained the case where as a mounting component, the transformer 4 is disposed at a position avoiding the virtual center line CL of the substrate 3; however, it may be allowed that as a mounting component, an electrolytic capacitor is disposed at a position avoiding the virtual center line CL of the substrate 3. As illustrated in FIG. 11, in general, an electrolytic capacitor 6 is mounted on the substrate 3 in such a way that the leads thereof are pulled out from the bottom surface of a cylindrical columnar electrolytic-capacitor main body portion and are adhered to the substrate 3 so that the bottom surface of the electrolytic-capacitor main body portion faces the surface of the substrate 3. In general, in comparison with any other capacitor such as a ceramic capacitor, an electrolytic capacitor requires a small mounting area, for its electrostatic capacitance, on the substrate 3; therefore, the substrate 3 can be downsized. However, an electrolytic capacitor is a so-called tall component; in general, the height of the gravity center thereof from the mounting surface of the substrate 3 is large, in comparison with any other capacitor such as a ceramic capacitor. Accordingly, when surface-direction vibration occurs in the substrate 3, bending in the substrate 3, caused through propagation, to the substrate 3, of the vibration, with which inertial force exerted on the electrolytic-capacitor main body portion makes the head-top portion of the electrolytic-capacitor main body portion swing as if a pendulum, is liable to become large. In addition, when even in the case of an electrolytic capacitor having one and the same electrostatic capacitance, the rated voltage thereof becomes high, the height of the electrolytic-capacitor main body portion becomes larger; thus, the height of the gravity center thereof from the substrate 3 also becomes larger. Accordingly, when an electrolytic capacitor having a higher rated voltage is adopted so as to raise the voltage to be applied to the electric-power conversion apparatus, the bending in the substrate 3 that occurs when surface-direction vibration occurs in the substrate 3 becomes larger.

As described above, although as a mounting component, an electrolytic capacitor is mounted on the substrate 3, the electrolytic capacitor is mounted on a position avoiding the virtual center line CL; thus, as is the case with Embodiment 1, it is made possible to increase the frequency of the resonance that is caused to occur in the substrate 3 by vibration exerted on the substrate 3 and that has its nodes at the connection portions 32a and 32b and its loop in the area sandwiched between the connection portions 32a and 32b; moreover, when the resonance occurs, it is made possible to suppress the amplitude of the displacement in the normal direction of the substrate 3.

In addition, in each of foregoing Embodiments, there has been explained the case where the semiconductor module 2 is held to the bottom portion 11 of the case 1 by being adhered to the cooling device 12 through soldering in such a way that the bottom surface of the main body portion 21 is adhered to the cooling device 12; however, the method of holding the semiconductor module 2 is not limited thereto, as long as the semiconductor module 2 is held to the case 1; for example, it may be allowed that the semiconductor module 2 is held to the case 1 in such a way that a spring member presses down the semiconductor module 2 so as to press the bottom surface thereof against the cooling device 12.

In addition, in each of foregoing Embodiments, there has been explained the case where the control terminal 22 is made of copper or aluminum; however, it may be allowed that the control terminal 22 is made of an alloy including at least one of copper and aluminum, as long as the control terminal 22 is adhered to the connection portion 32a or 32b so that the control terminal 22 electrically connects the substrate 3 with the switching device 21a of the semiconductor module 2 and supports the substrate 3.

In each of foregoing Embodiments, there has been explained an electric-power conversion apparatus to be fixed to a motor as an example of a vehicle power train apparatus to be mounted in a vehicle; however, not being limited to a vehicle power train apparatus, an effect that bending in a substrate can be suppressed is demonstrated, because when the electric-power conversion apparatus is fixed to a component of a vehicle in which vibration occurs and hence vibration occurs in the substrate, substrate resonance in which the connection portions are nodes and a loop is made in the region sandwiched between the facing connection portions hardly occurs.

In each of foregoing Embodiments, there has been explained an electric-power conversion apparatus to be mounted in a vehicle; however, not being limited to an electric-power conversion apparatus to be mounted in a vehicle, an effect that bending in a substrate can be suppressed is demonstrated, because when the electric-power conversion apparatus according to the present disclosure is utilized under an environment in which vibration occurs and hence vibration occurs in the substrate, substrate resonance in which the connection portions are nodes and a loop is made in the region sandwiched between the facing connection portions hardly occurs.

In addition, it is included in the scope of the technical idea disclosed in the foregoing embodiments that the foregoing embodiments are appropriately combined with one another, modified, or omitted.

Hereinafter, respective features disclosed in the present disclosure will collectively be described as appendixes.

(Appendix 1) An electric-power conversion apparatus comprising:
a semiconductor module having a main body portion held to a case and two or more control terminals pulled out from the main body portion;
a substrate on which respective connection portions to which the two or more control terminals are fixed in substantially linear alignment are arranged in such a way as to be substantially parallel to the alignment direction and in such a way as to face each other; and
a mounting component that is mounted at a position, on the substrate, avoiding a virtual center line, the respective distances from which to the facing connection portions are equal to each other, and whose gravity center is apart from a mounting surface of the substrate in a normal direction thereof.
   (Appendix 2) The electric-power conversion apparatus according to Appendix 1, wherein, when the substrate is viewed from thereabove, the mounting component is mounted in an area sandwiched between a first line that passes through one of the facing connection portions and extends in the alignment direction of the connection portion and a second line that passes through the other one of the facing connection portions and extends in the alignment direction of the connection portion.
   (Appendix 3) The electric-power conversion apparatus according to Appendix 2, wherein the height, from the mounting surface, of the gravity center of the mounting component is the largest among respective heights of the gravity centers of components to be mounted in the area sandwiched between the first line and the second line.
   (Appendix 4) The electric-power conversion apparatus according to any one of Appendixes 1 through 3,
wherein the mounting component has a mounting-component main body portion and one or a plurality of leads pulled out from the mounting-component main body portion,
wherein a front-end portion of the lead is adhered to the substrate, so that the mounting component is mounted on the substrate, and
wherein the lead is pulled out from a connection-portion side of the mounting-component main body.
   (Appendix 5) The electric-power conversion apparatus according to any one of Appendixes 1 through 4,
wherein the mounting component has a mounting-component main body portion and two or more leads pulled out from the mounting-component main body portion,
wherein respective front-end portions of the two or more leads are adhered to the substrate, so that the mounting component is mounted on the substrate, and
wherein respective adhesion portions between the front-end portions of the two or more leads and the substrate are aligned substantially linearly and substantially in parallel with the connection portion.
   (Appendix 6) The electric-power conversion apparatus according to Appendix 2,
wherein the mounting component has a mounting-component main body portion and two or more leads pulled out from the mounting-component main body portion,
wherein respective groups of the two or more leads are pulled out from the mounting-component main body in such a way as to face each other,
wherein respective front-end portions of the two or more leads are adhered to the mounting surface of the substrate, so that the mounting component is mounted on the substrate, and
wherein a direction in which the respective groups of the leads face each other coincides with the direction in which the connection portions face each other.
   (Appendix 7) The electric-power conversion apparatus according to Appendix 6, wherein respective adhesion portions between the lead front-end portions and the substrate are arranged outside the mounting-component main body, when the substrate is viewed from thereabove.
   (Appendix 8) The electric-power conversion apparatus according to any one of Appendixes 6 and 7, wherein the lead has at least one lead bending portion in a region, of part thereof exposed from the mounting-component main body, between the mounting-component main body and the front-end portion adhered to the substrate.
   (Appendix 9) The electric-power conversion apparatus according to any one of Appendixes 1 through 8,
wherein the substrate has one or a plurality of supported portions to be supported by the case, and
wherein the supported portion is formed at a position avoiding an area sandwiched between the connection portions of the substrate.
   (Appendix 10) The electric-power conversion apparatus according to any one of Appendixes 1 through 9, wherein a front-end portion of the control terminal is soldered to the substrate, so that the control terminal is adhered to the substrate.
   (Appendix 11) The electric-power conversion apparatus according to Appendix 10,
wherein two or more through-holes provided in the substrate are linearly aligned, so that the connection portion is formed, and
wherein the front-end portion of the control terminal is adhered to the substrate in such a way as to be inserted into the through-hole and then soldered thereto.
   (Appendix 12) The electric-power conversion apparatus according to any one of Appendixes 1 through 11,
where a bottom surface of the main body portion of the semiconductor module is held to the case, and
wherein the control terminal has at least one bent portion in a region, of part thereof exposed from the main body portion, between the main body portion and a portion adhered to the connection portion.
   (Appendix 13) The electric-power conversion apparatus according to Appendix 12,
wherein the bent portion is formed through press working, and
wherein a press-direction thickness of the bent portion of the control terminal is the same as or smaller than 1 mm.
   (Appendix 14) The electric-power conversion apparatus according to any one of Appendixes 1 through 13, wherein the mounting component is mounted on a surface, of the substrate, that faces the main body portion of the semiconductor module.
   (Appendix 15) The electric-power conversion apparatus according to any one of Appendixes 1 through 13, wherein the mounting component is mounted on a surface, of the substrate, that is reverse to a surface facing the main body portion of the semiconductor module.
   (Appendix 16) The electric-power conversion apparatus according to any one of Appendixes 1 through 15, wherein the two or more mounting components are mounted on the substrate in such a way as to be arranged in a zigzag manner across the virtual center line.
   (Appendix 17) The electric-power conversion apparatus according to any one of Appendixes 1 through 16,
wherein the substrate has a ground strip conductor whose electric potential is the same as that of the case, and
wherein the ground strip conductor is disposed on the virtual center line, when the substrate is viewed from thereabove.
   (Appendix 18) The electric-power conversion apparatus according to any one of Appendixes 1 through 18, wherein the semiconductor module is formed in such a way that part of the control terminal and a switching device are sealed by a sealing resin through molding.
   (Appendix 19) The electric-power conversion apparatus according to Appendix 18,
wherein a circuit is formed on the substrate, and
wherein a dummy terminal is included in the two or more control terminals.
   (Appendix 20) The electric-power conversion apparatus according to any one of Appendixes 1 through 19, wherein the mounting component is a transformer.
   (Appendix 21) The electric-power conversion apparatus according to any one of Appendixes 1 through 19, wherein the mounting component is an electrolytic capacitor.
   (Appendix 22) The electric-power conversion apparatus according to any one of Appendixes 1 through 21, the electric-power conversion apparatus being mounted in a vehicle.
   (Appendix 23) The electric-power conversion apparatus according to Appendix 22, the electric-power conversion apparatus being fixed to a vehicle power train apparatus mounted in the vehicle.

What is claimed is:

1. An electric-power conversion apparatus comprising:
a semiconductor module having a main body portion held to a case and two or more control terminals pulled out from the main body portion;
a substrate on which respective connection portions to which the two or more control terminals are fixed in substantially linear alignment are arranged in such a way as to be substantially parallel to the alignment direction and in such a way as to face each other; and
a mounting component that is mounted at a position, on the substrate, avoiding a virtual center line, the respective distances from which to the facing connection portions are equal to each other, and whose gravity center is apart from a mounting surface of the substrate in a normal direction thereof.

2. The electric-power conversion apparatus according to claim 1, wherein, when the substrate is viewed from thereabove, the mounting component is mounted in an area sandwiched between a first line that passes through one of the facing connection portions and extends in the alignment direction of the connection portion and a second line that passes through the other one of the facing connection portions and extends in the alignment direction of the connection portion.

3. The electric-power conversion apparatus according to claim 2, wherein the height, from the mounting surface, of the gravity center of the mounting component is the largest among respective heights of the gravity centers of components to be mounted in the area sandwiched between the first line and the second line.

4. The electric-power conversion apparatus according to claim 1,
wherein the mounting component has a mounting-component main body portion and one or a plurality of leads pulled out from the mounting-component main body portion,
wherein a front-end portion of the lead is adhered to the substrate, so that the mounting component is mounted on the substrate, and
wherein the lead is pulled out from a connection-portion side of the mounting-component main body.

5. The electric-power conversion apparatus according to claim 1,
wherein the mounting component has a mounting-component main body portion and two or more leads pulled out from the mounting-component main body portion,
wherein respective front-end portions of the two or more leads are adhered to the substrate, so that the mounting component is mounted on the substrate, and
wherein respective adhesion portions between the front-end portions of the two or more leads and the substrate are aligned substantially linearly and substantially in parallel with the connection portion.

6. The electric-power conversion apparatus according to claim 2,
wherein the mounting component has a mounting-component main body portion and two or more leads pulled out from the mounting-component main body portion,
wherein respective groups of the two or more leads are pulled out from the mounting-component main body in such a way as to face each other,
wherein respective front-end portions of the two or more leads are adhered to the mounting surface of the substrate, so that the mounting component is mounted on the substrate, and
wherein a direction in which the respective groups of the leads face each other coincides with the direction in which the connection portions face each other.

7. The electric-power conversion apparatus according to claim 6, wherein respective adhesion portions between the lead front-end portions and the substrate are arranged outside the mounting-component main body, when the substrate is viewed from thereabove.

8. The electric-power conversion apparatus according to claim 6, wherein the lead has at least one lead bending portion in a region, of part thereof exposed from the mounting-component main body, between the mounting-component main body and the front-end portion adhered to the substrate.

9. The electric-power conversion apparatus according to claim 1,
wherein the substrate has one or a plurality of supported portions to be supported by the case, and
wherein the supported portion is formed at a position avoiding an area sandwiched between the connection portions of the substrate.

10. The electric-power conversion apparatus according to claim 1, wherein a front-end portion of the control terminal is soldered to the substrate, so that the control terminal is adhered to the substrate.

11. The electric-power conversion apparatus according to claim 10,
wherein two or more through-holes provided in the substrate are linearly aligned, so that the connection portion is formed, and
wherein the front-end portion of the control terminal is adhered to the substrate in such a way as to be inserted into the through-hole and then soldered thereto.

12. The electric-power conversion apparatus according to claim 1,
where a bottom surface of the main body portion of the semiconductor module is held to the case, and
wherein the control terminal has at least one bent portion in a region, of part thereof exposed from the main body portion, between the main body portion and a portion adhered to the connection portion.

13. The electric-power conversion apparatus according to claim 12,
wherein the bent portion is formed through press working, and
wherein a press-direction thickness of the bent portion of the control terminal is the same as or smaller than 1 mm.

14. The electric-power conversion apparatus according to claim 1, wherein the mounting component is mounted on a surface, of the substrate, that faces the main body portion of the semiconductor module.

15. The electric-power conversion apparatus according to claim 1, wherein the mounting component is mounted on a surface, of the substrate, that is reverse to a surface facing the main body portion of the semiconductor module.

16. The electric-power conversion apparatus according to claim 1, wherein the two or more mounting components are mounted on the substrate in such a way as to be arranged in a zigzag manner across the virtual center line.

17. The electric-power conversion apparatus according to claim 1,
wherein the substrate has a ground strip conductor whose electric potential is the same as that of the case, and
wherein the ground strip conductor is disposed on the virtual center line, when the substrate is viewed from thereabove.

18. The electric-power conversion apparatus according to claim 1, wherein the semiconductor module is formed in such a way that part of the control terminal and a switching device are sealed by a sealing resin through molding.

19. The electric-power conversion apparatus according to claim 18,
wherein a circuit is formed on the substrate, and
wherein a dummy terminal is included in the two or more control terminals.

20. The electric-power conversion apparatus according to claim 1, wherein the mounting component is a transformer.

21. The electric-power conversion apparatus according to claim 1, wherein the mounting component is an electrolytic capacitor.

22. The electric-power conversion apparatus according to claim 1, the electric-power conversion apparatus being mounted in a vehicle.

23. The electric-power conversion apparatus according to claim 22, the electric-power conversion apparatus being fixed to a vehicle power train apparatus mounted in the vehicle.
